(19) United States
(12) Patent Application Publication
(10) Pub. No.: US 2016/0335602 A1
(43) Pub. Date: Nov. 17, 2016

(54) Human Capital Management System and Method

(71) Applicant: Capital Preferences, Ltd., Staten Island, NY (US)

(72) Inventors: Shachar Kariv, Piedmont, CA (US); Jay Womack, Cherry Hill, NJ (US); Bernard Del Rey, Christchurch (NZ); Daniel S Silverman, Paradise Valley, AZ (US)

(73) Assignee: Capital Preferences, Ltd., Staten Island, NY (US)

(21) Appl. No.: 15/153,776

(22) Filed: May 13, 2016

Related U.S. Application Data
(60) Provisional application No. 62/160,854, filed on May 13, 2015.

(51) Int. Cl. G06Q 10/10; G09B 19/00; G06Q 10/06

(52) U.S. Cl. CPC G06Q 10/1053; G06Q 10/0635; G06Q 10/06393; G09B 19/00

(57) ABSTRACT

Disclosed is a preference-based human resources management system and method. In one embodiment, the present system includes a user interface for obtaining responses to a series of textual or graphical questions via a game or an activity, from a user, which can be algorithmically combined with defined utility curves to identify multi-dimensional measures of individual risk aversion, loss aversion, ambiguity aversion, time preferences, and social (distributional) preferences. These preferences define a user's economic fingerprint that can be used to conduct job screening, recruit potential training, conduct job training, and make other job-related decisions.

### CROSS REFERENCE TO RELATED APPLICATIONS

This application claims the benefit of, and priority from, U.S. Provisional Patent Application No. 62/160,854, filed May 13, 2015, the entire disclosures of which are incorporated herein by reference.

### FIELD OF THE INVENTION

The present invention relates generally to human resources application and, more particularly, to the use of a computer interface to obtain responses to a series of textual or graphical questions that can be algorithmically combined with defined utility curves to identify multi-dimensional measures of individual preferences for use in a number of human capital/human resource applications.

### BACKGROUND OF THE INVENTION

Some of the most critical decisions facing workplaces are talent management and talent development because the results of these factors are in all facets of a company. It is paramount to access the skills the organization needs to implement its strategy and the plan for recruiting and managing the critical talent. Many human resources departments, however, face several challenges in managing and developing talent. Particularly, existing screening and evaluation processes do not allow recruiters, managers, and/or employers to analyze comprehensive data in order to fully assess an employee or a candidate for a specific job type.

In this regard, existing screening and evaluation processes are generally limited to shifting through job applications, portfolios, resumes, and conducting brief interviews. While these processes allow recruiters, managers, and/or employers to form a basic understanding of an individual's experiences and accomplishments, these processes do not measure essential qualities that can greatly affect job performance, such as risk inclination, decision-making abilities (DMA), and decision-making quality (DMQ). Therefore, there is a need in the prior art for an improved method of talent management and development that can build more comprehensive individual job portfolios in order for employers to recruit and retain optimal talent. In this regard, the invention described herein addresses this problem.

### SUMMARY OF THE INVENTION

In view of the disadvantages inherent in the known types of human resources management systems and methods now present in the prior art, the present invention provides an improved preference-based human resources application.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

The talent management and development method of the present invention is based upon algorithmically recovered preferences such as risk aversion, loss aversion, ambiguity (uncertainty) aversion, present bias and time discounting (individual internal rate of return or time preferences), and social (distributional) preferences. These preferences are neither inclusive nor exclusive in that any one or more of the preferences may be used in developing personalized utility curves or indifference curves, wherein the utility or indifference curves provide insight into their performance potential or actual performance. The combination of the foregoing preference measures allow for a more comprehensive individual profiles.

The preferences can be measured using a variety of games, activities, and/or tests that can output a set of metrics or scores that can be combined to produce a hiring index, promotion and job grading, talent assessment, benefits evaluation, and the like. A utility curve is developed for each test implementation: 1) decisions under risk, which measures risk and loss aversion; 2) decisions under ambiguity, which measures risk and ambiguity aversion; 3) time preferences, which measures implied internal rate of return (IRR) and present bias, if any; and 4) distributional preferences or social preferences. In some embodiments, two or more individual utility functions can be combined using a weighting scheme to create utility functions for groups of two or more individuals.

In some embodiments, the present method includes outputting a DMQ score, a risk score, and an ambiguity score, wherein these scores can be used to make tradeoffs. The DMQ scores can be measured by calculating how nearly individual choice behavior in a test complies with individual utility maximization. Certain job types, for example, may require individuals to have a high DMQ score and low risk score, while other job types may require moderate risk score and a high ambiguity score. In some embodiments, it is contemplated that each score for each job type comprises a predetermined value so as to allow recruiters, managers, and/or employers to compare an employee or a candidate's scores to the predetermined values. Thus, understanding the availability of talent in combination with knowing how it is critical for the business strategy allows the present method to lead to a more interactive relationship between the strategic choices of the organization and how its talent is trained and managed.

Some embodiments of the present method include recruiting talent or developing talent internally by integrating the games, activities, and/or tests into a periodic evaluation system in which individuals can take multi-source assessments, including self- and peer-assessments, in order to update utility curves in accordance with the individuals' preferences changes over time. In this regard, it is also contemplated that the games, activities, and/or tests can be modified or adjusted over time or in context to fit a particular situation. In this way, the present method would help organizations understand what they can do to add the right talent: whether it is best recruited or best internally developed, and whether it is even possible to develop the right talent in order to implement business strategy.

Some embodiments include a system comprising a memory unit having preference based human resources management instructions, and a processor to execute the instructions via an application (e.g., a web application, a website, a stand-alone application, a mobile application, etc.). This allows the system to identify an individual's “point-in-time” economic fingerprint, which defines the individual's preference measures and comprises comprehensive individual profiles. In this way, the system uses the economic fingerprint to conduct job screening and recruiting, manage employee performances, and conduct predictive analysis for job markets.

Some embodiments of the present invention further account for changes in an individual's preferences over time. More specifically, the application is configured to evaluate an individual's job performances and recommend training by maximizing the utility calculated using a customized utility function that is defined by the foregoing preference measures, subject to constraints. The game module can also modify tests such that an axis on the test can be scaled to reflect a specific variable such as an individual's role and adjusted in context to fit a particular situation (e.g., promotion).

In this regard, the present invention significantly differs from traditional approach to human resources application in that it offers a flexible, interactive approach to job screening, recruiting, and evaluation that can accommodate the various utility functions and deliver a prospective employee and/or job training that maximizes profit subject to target expected return and constraints.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 depicts an exemplary block diagram of the present system.

FIGS. 2A through 2D show exemplary embodiments of the game interface of the present invention.

FIG. 3 depicts an exemplary bundle optimization process.

FIG. 4 depicts an exemplary bundle mapping process.

FIG. 5 depicts an exemplary flow chart of the scoring process of the present method.

FIG. 6 depicts the job screening and recruiting process of the present method.

FIG. 7 depicts the performance management process of the present method.

FIG. 8 depicts the predictive analysis process of the present invention.

### DETAILED DESCRIPTION OF THE INVENTION

The present invention is directed towards a method and system for human resources management. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Some portions of the present invention are presented in terms of algorithms and other representations of operations on data bits or binary digital signals within a computer memory. It is to be appreciated that determinations or inferences referenced throughout the subject specification can be practiced through the use of artificial intelligence techniques. More specifically, the terms “processing,” “computing,” “calculating,” “determining,” “establishing,” “analyzing,” “identifying,” “checking,” or the like, may refer to operations and/or processes of a computer, a computing platform, a computer system, or other electronic device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. The terms “end user” or “user” as used herein may refer to any “customer,” “individual,” “client,” “test taker,” “player,” “employee,” “prospective employee,” “candidate,” or another operator of a user device unless the context clearly suggests otherwise. Finally, the terms “activity,” “game,” and “test” are used interchangeably unless the context clearly suggests otherwise.

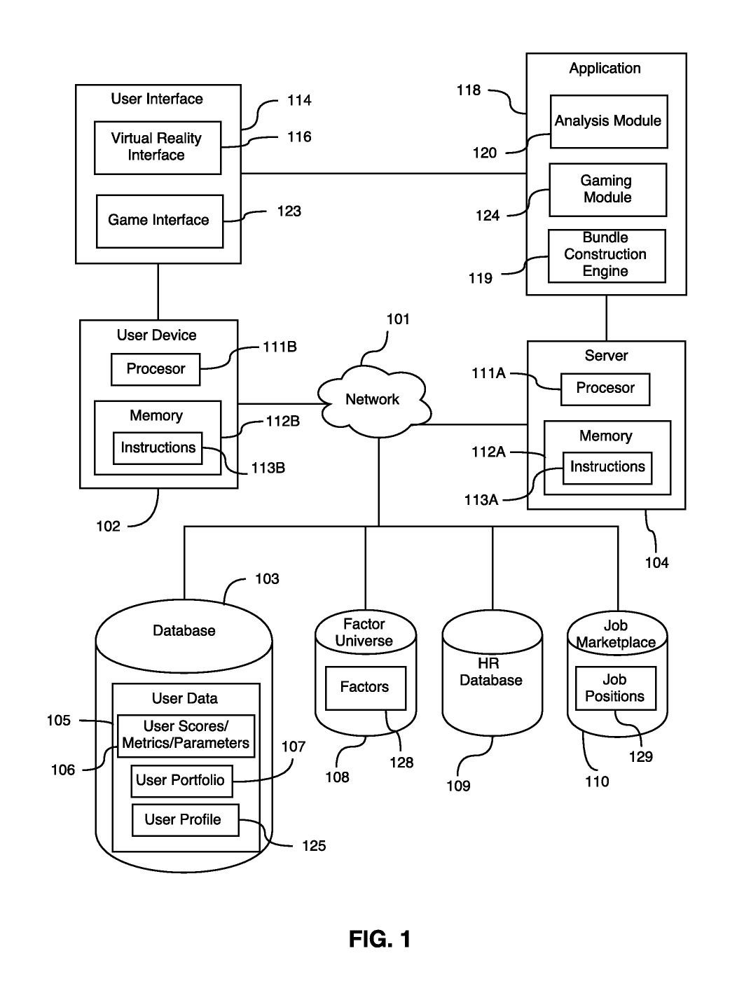

Referring now to FIG. 1, there is shown an exemplary block diagram of the present system. The present system comprises at least one user device 102 that is operated by an end user, wherein the user device 102 comprises various types of computer systems, such as a desktop computer, a laptop, a smart phone, a personal digital assistant (PDA), a computer tablet, or the like. In this regard, the user device comprises a processor 111B, a memory unit 112B for storing instructions 113B, and other components for operating the same, such as controllers, input/output units (e.g., keyboard, mouse, touch screen, microphone, speakers, display screen, monitor), communication units, operating systems, and the like.

The user device 102 is connected to a network 101 (e.g., the Internet, LAN), and is configured to access a user interface 114 that is available via an application 118, wherein the application 118 comprises a website, a web application, a mobile application, and other types of downloadable and/or non-downloadable program. It is contemplated that the system may further comprise an application server 104 for supporting the application 118, wherein the server 104 also comprises a computer system comprising a processor 111A and a memory unit 112A having instructions 113A stored thereon.

The user interface 114 facilitates communication between the user device 102 (and hence the end user) and one or more elements of the present system (e.g., the application 118). In this regard, the user interface 114 may be configured to allow users to enter commands, to input and receive information, to play games, complete activities, take tests, to define their preference parameters and constraints, to receive their performance analysis, and/or to view reports. Without limitation, the application 118 may include a gaming module 124, a bundle construction engine 119, an analysis module 120, and other suitable human resources management tools.

The user interface 114 comprises a graphic user interface for interacting with an end user via the user device 102. In one embodiment, the graphic user interface comprises a virtual reality interface 116 that allows the end user to play games and complete interactive tasks or activities in a virtual world. For instance, the user may be invited to make work-related decisions in the context of risk, time, or distributional preferences. The user would be able to see, via the user interface 114, the analysis or view the outcomes of their decisions that aid in future decision making, job positions, and job training. The virtual world can be tailored to each user so that the games and activities are more context-specific or job-specific. Alternatively, the virtual world can imitate real-life experience and tasks in various work environments (e.g., managing projects, providing presentations at meetings, making work-related decisions).

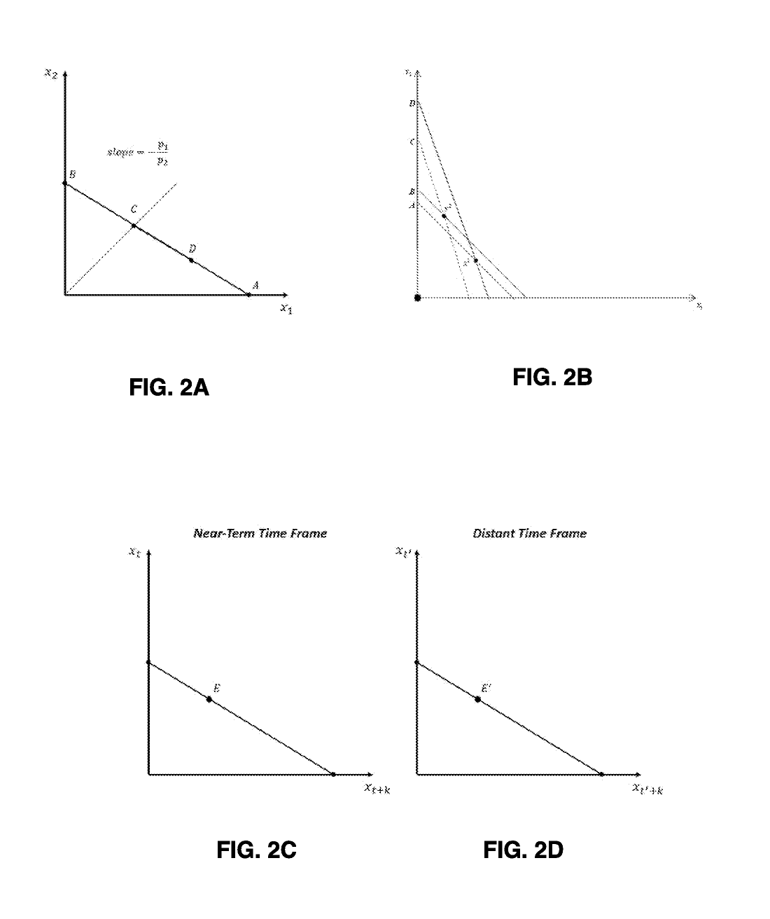

In another embodiment, the user interface 114 allows the end user to play games or complete activities via 2D and/or 3D game interface 123. Without limitation, the 2D and/or 3D game interface 123 can comprise graphs or charts that can be manipulated by the user, as depicted in FIG. 2A. A gaming module 124 of the application 118 controls the game interface 123, as well as the games and activities provided in the virtual reality interface 116. The gaming module 124 allows the end user to make one or more tradeoff decisions between two or more arbitrary items or outcomes related to risk, uncertainty, time, and social (distributional) preferences in the domain of risk preferences, and/or distributional preferences via the game interface 123 or the virtual reality interface 116.

The gaming module 124 can individually tailor games or activities based on various factors such as socio-economic factors of the end user and the end user's career goals, among types of factors 128, for example, from a factor universe 108. The results of the user's decisions or performances from the games or activities, or the metrics derived from the games or activities are used to calculate preference parameters and scores or data points, with statistical confidence intervals 106. The data points or scores represent the end user's “point-in-time” economic fingerprint.

The metrics, preference parameters, game scores, or data points 106 for each end user are associated with respective user data 105 and stored in a database 103 so that it can be retrieved later for various applications, such as job screening and recruiting, performance management, and predictive analysis (for HR-related outcomes). The database 103 further comprises other types of user data 103 associated with one or more users. For instance, the user data 103 comprises user profile 125 that includes demographic information (e.g., age, sex, marital status, occupation, etc.), career goals, work experiences, education, certification and licenses, and other information corresponding to one or more users.

In some embodiments, the application 118 utilizes users' inputs or metrics from the games or activities to automatically calculate preference parameters, with confidence intervals, for individual users based on internally defined utility functions corresponding to one or more user-specific applications (i.e., job screening and recruiting, role assignment, performance management, and predictive analysis).

In some embodiments, the analysis module 102 of the application 118 may be capable of analyzing the metrics to, for example, identify individual risk preferences, individual time preferences, and individual distributional preferences. Additionally, the application 118 may be capable of automatically confirming that the data points are consistent with any preference ordering. The application 118 can also utilize the metrics to identify any user-specific pattern (e.g., behavioral pattern) and generate predictive data corresponding to the user.

In some embodiments, the application 118 may be capable of automatically calculating (e.g., via a bundle construction engine 119) best-fit bundle or optimizing bundle to maximize the utility function, wherein a bundle represents a group of tangible and/or intangible goods (e.g., a set of team members, a set of job assignments, a set of hiring decisions, etc.). Without limitation, a bundle can be talent oriented (a talent bundle) or oriented with human capital (a human capital bundle). In this regard, the application 118 takes into account individual risk preferences, individual time preferences, and/or individual distributional preferences to optimize a bundle. Said another way, the individual preferences determine the performance of an object or a bundle that an HR department is trying to optimize.

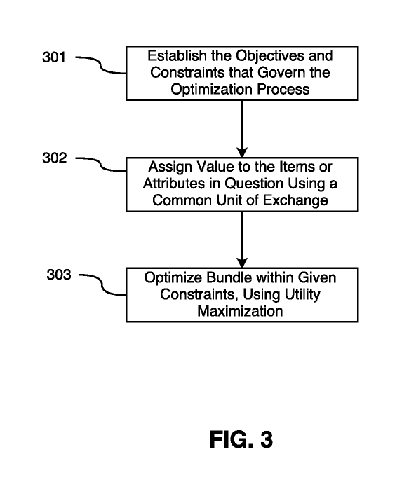

An exemplary embodiment of the bundle optimization process of the present method is illustrated in FIG. 3. One or more of the operations of FIG. 3 may be performed by one or more elements of the present system as illustrated in FIG. 1. The optimization process includes establishing, via, for example, the bundle construction engine 119 (FIG. 1), the objectives and constraints that govern the optimization process 301. The process further includes assigning value to the items or attributes in question using a common unit of exchange 302 and optimizing a bundle within given constraints, using utility maximization 303. In some embodiments, the optimization is executed using nonlinear optimization techniques that are robust to problems that involve finding global minima/maxima for various smooth and non-smooth functional forms.

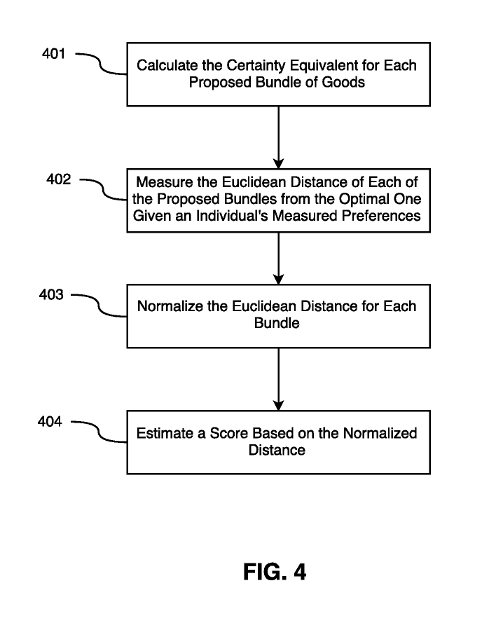

Additionally, bundles can be mapped by maximizing the certainty equivalent for a given level of utility, conditional upon measured preferences of a user, in mapping bundles for the purposes of scoring or ordinal ranking. The process for bundle mapping process is illustrated in FIG. 4, wherein one or more of the operations of FIG. 4 may be performed by one or more elements of the present system as illustrated in FIG. 1.

The process for deriving a score for mapping bundles includes calculating the certainty equivalent (CE) for each of the proposed bundles of goods 401 using the utility functions for decisions under risk, decisions under ambiguity, social (distributional) preferences, and time preferences. The process further includes measuring the Euclidean distance 402 and normalizing each element of the resulting distance vector by the maximum distance 403. The normalized distance is then used to estimate a score 404, which can be used for measuring a fit for job types and team membership. It is noted that the process can utilize other types of distance metrics, depending upon embodiment.

In some embodiments, the application 118 may be capable of automatically conducting job screening and job recruiting by using a user's metrics, scores or data points derived from the preference parameters, constraints, and/or other predictive data corresponding to the user. Additionally, the application 118 may be capable of measuring fit for specific job positions. In this regard, the application 118 communicates with the HR database 109 comprising HR data to access employers' job screening requirements therefrom. Additionally, the application 118 communicates with the job marketplace 110 to access information and recommend work and job positions 129 therefrom.

In some embodiments, the application 118 may be capable of managing or rating individual job performances (e.g., financial performance) using a user's metrics, scores or data points derived from the preference parameters, and/or other constraints. In this regard, the application 118 may be adapted to interact with the job marketplace 110 to access requirements for specific job positions 126 therein. Additionally, the application 118 communicates with the HR database 109 to access employer-specific job evaluation criteria therefrom. Some embodiments of the HR database 109 further comprise job training information for specific job positions 129 and roles.

In some embodiments, the application 118 may be capable of conducting predictive analysis. In this regard, the application 118 can use a user's metrics, scores or data points derived from the preference parameters, and/or other constraints to determine the likelihood of HR-related outcomes given analysis of a universe of data and scores. Without limitation, HR-related outcomes comprise promotion, demotion, successfully completing a project or reaching a milestone, and making a new hire, among others.

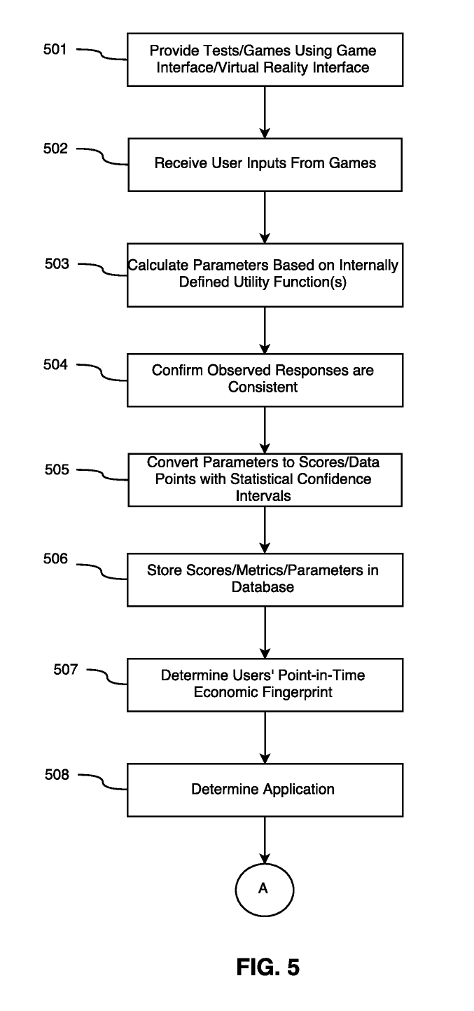

Reference is also made to FIGS. 5 through 8, which schematically illustrates exemplary methods of the present invention. One or more of the operations of FIGS. 5 through 8 may be performed by one or more elements of the present system as illustrated in FIG. 1. As indicated in block 501, the method includes administering tests or providing games, or activities for measuring a person's job-related preferences to one or more users using the game interface 123 (FIG. 1) and/or virtual reality interface 116 (FIG. 1).

As indicated in block 502, the method includes receiving user inputs or metrics corresponding to one or more users from the administered games or activities. For example, the gaming module 124 (FIG. 1) may keep track of a user's activities or decisions and allow the user to record or save his or her decisions manually or automatically record the same in corresponding user's data 105 (FIG. 1). As indicated in block 503, the method includes calculating preference parameters based on internally defined utility functions via, for example, the application 118 (FIG. 1) using the user inputs from the games or activities provided by the gaming module 124.

### Individual Risk Preferences

In one embodiment, the games or activities measure individual risk preferences. In this regard, “risk preferences” measure an end user's attitude towards risk. Each assessment comprises a series of decisions. Preferably, each assessment for the user's attitude toward risk may comprise eight or more independent decision rounds. In this way, the application 118 (FIG. 1) can gather a large enough sample size to objectively measure variation and increase quality of the data obtained by confirming that the user's responses are consistent with any preference ordering. In each round, the user is asked to allocate an endowment between two arbitrary terms, labeled x₁ and x₂. The implied price for the items on either axis must translate into units of value that are denominated in the same units of exchange as the endowment. The x₁ account corresponds to the x-axis and the x₂ account corresponds to the y-axis in a two-dimensional graph, as depicted, for example, in FIG. 2A.

Each choice involves choosing a point on a budget line of possible combination of payments, wherein the line represents a budget constraint. The point C, which lies on the 45-degree line, corresponds to a portfolio with a certain payoff. By contrast, point A and point B represent a decision in which the entire endowment is invested in the option that pays off in state 1 or state 2, respectively. A portfolio at point C is called a “safe decision” and portfolios at points A and B are called “boundary decision.” A portfolio at D is neither a safe nor a boundary portfolio, and is called an “intermediate decision.”

Each round of the games or activities starts by having the gaming module 124 (FIG. 1) select a budget line randomly. The payoffs at various points along the line depend on the payoffs in states 1 and 2. The budget lines selected for each decision problem or round are independent of each other and of the budget lines selected for other individuals. The axes are scaled to represent a meaningful economic choice given the domain in which preferences are being measured. When completing individual decision problems within the game or activity, to choose a combination, for example, the user can utilize the user device 102 (FIG. 1) to drag or move a point on the graph to the desired location.

The games or activities are preferably configured to measure three risk attitudes by measuring levels of preference (i.e., aversion/tolerance) to uncertainty under the following two conditions: 1) uncertain outcomes with known probabilities; and 2) uncertain outcomes with unknown probabilities. In the first instance, users make decisions under conditions where outcomes are uncertain, but the probabilities of those outcomes are known. A single line with two outcomes with known probabilities represents the most basic form of decisions under risk. The combination of decisions across multiple lines enables the identification of loss aversion. Therefore, from these decisions, users' preferences for risk (risk aversion) and loss (loss aversion) are measured.

In the second scenario, users make decisions under conditions where both the outcomes and the probability of those outcomes are uncertain (ambiguity). A single line of the graph with two known outcomes but unknown probabilities is a variant of basic risk taking. However, in this instance, the combination of decisions across multiple lines enables the identification of ambiguity aversion. As a result, from these decisions, users' preferences towards ambiguity (ambiguity aversion) are measured. These three aversions: risk aversion; loss aversion; and ambiguity aversion, represent a rich description of a user's risk preferences. Risk aversion measures individual attitudes towards risk-taking; loss aversion measures the additional aversion a user experiences when dealing with outcomes that falls short of their expectations versus those that meet or exceed them; ambiguity aversion is the additional aversion a user experiences when dealing with ambiguous situations versus ones that are more certain.

In this regard, the application 118 (FIG. 1) utilizes the loss/disappointment aversion over portfolios (x₁, x₂) and embeds the standard Expected Utility Theory (EUT) representation as a parsimonious and tractable special case and allows for the estimation of the parameter values for risk and loss aversion based on the decisions. In some embodiments, the application 118 (FIG. 1) may utilize the Hyperbolic Absolute Risk Aversion (HARA) class of utility functions (including negative exponential (CARA) and power (CRRA) utility functions) that, given special cases, include the quadratic utility function, exponential utility function, and power utility function.

The application 118 (FIG. 1) utilizes the calculated parameters of risk aversion and loss aversion to measure expected utility (to determine preference-based bundle optimization for risk vs. loss and ambiguity), accounting for the separate treatment of outcomes that meet or exceed expectations as well as that fall short of expectations.

### Individual Time Preferences

In one embodiment, the games or activities measure individual time preferences. In this regard, “time preferences” measure an individual's preferences for the allocation of consumption or value over time. Each assessment comprises a series of decisions. Preferably, each assessment for the user's attitude toward time may comprise an even number of ten or more independent decision rounds (n rounds). In each of the first n/2 rounds, an individual is asked to choose an endowment that will be received between two arbitrary points in time, t and t+k, wherein t represents an earlier time than t+k, which is k units of time after t. The xₜ amount corresponds to the y-axis and the Xₜ₊ₖ amount corresponds to the x-axis in a two-dimensional graph, as depicted in FIGS. 2C and 2D.

Each choice involves choosing a point on a budget line of possible combinations of payments. Each round starts by having the gaming module 124 (FIG. 1) select a budget line randomly. The budget lines selected for each decision problem are independent of each other and of the budget lines selected for other individuals. In remaining n/2 rounds, the gaming module 124 (FIG. 1) asks a user to choose an endowment that will be received between two arbitrary points in time, t′ and t′+k, where t′ is some number>k periods after t. The x_{t′} amount corresponds to the y-axis and the x_{t′+k} amount corresponds to the x-axis in a two-dimensional graph.

Each choice involves choosing a point on a budget line of possible combinations of payments. In the latter rounds, the gaming module 124 (FIG. 1) randomly selects budget lines from the first n/2 rounds, without repetition. The axes are scaled to represent a meaningful economic choice given the domain in which preferences are being measured. When completing individual decision problems, to choose a combination, for example, the user can utilize the user device 102 (FIG. 1) to drag or move a point on the graph to the desired location.

Two forms of time preference are measured: 1) the degree to which a person exhibits present bias, or a strong preference for near-term payoffs (i.e., instant gratification); and 2) the implied rate at which an individual discounts money over time beyond the present (i.e., general time discounting). In the first instance, the users make decisions about how they would like to allocate an endowment, with certainty, between two points in time in the “near term,” as depicted in FIG. 2C. In the second instance, the user is asked to make decisions about how they would allocate an endowment over time in the “long term,” as depicted in FIG. 2D.

The application 118 (FIG. 1) utilizes utility functions over the allocation (xₜ, xₜ₊ₖ) to calculate the parameter values for a user's time preferences. The calculated parameters are used to measure discounted expected utility, and when integrated with risk preferences can account for the separate treatment of gains and losses. In this regard, the effects of individual time discounting are considered by optimizing consumption over some period of time, inclusive of any lump sum outflows.

### Individual Distributional Preferences

In one embodiment, the games or activities measure individual distributional preferences. In this regard, “distributional preferences” measure the degree to which a person prefers to allocate an endowment to themselves and others. Preferences for giving measures a user's preference for allocations to self versus an “other,” while social preferences measure the relative preferences given an allocation of money between two or more “others.” In both instances, the “other” can be a person, an entity, an organization, or a tangible/intangible good.

In other embodiments, distributional preferences measure the degree to which a person prefers to allocate resources between two or more goals. Relative preferences for goals measure a user's preference for allocations to one goal versus another goal. More generally, distributional preferences measure the relative preferences regarding the allocation of resources among multiple goals.

Each assessment comprises a series of decisions. Preferably, each assessment consists of eight or more independent decision rounds. In each round, the gaming module 124 (FIG. 1) asks a user to allocate an endowment or a bundle of goods that will be divided between those represented in the tradeoff scenario: self versus other; other versus other; goal versus goal; self versus other versus other; or goal versus goal versus goal. In the first three scenarios, preferences are measured in a two-dimensional space (as depicted in FIG. 2A), whereas preferences between self and two others or a goal and two other goals are measured concurrently using a three-dimensional space.

Each choice involves choosing a point on a budget line (or a budget surface in a self versus two others scenario) of possible combinations of payments. Each round starts by having the gaming module 124 (FIG. 1) select a budget line randomly. The budget lines selected for each decision problem are independent of each other and of the budget lines selected for other individuals. The axes are scaled to represent a meaningful economic choice (e.g., allocation of assets) given the domain in which preferences are being measured. When completing individual decision problems, to choose a combination, for example, the user can utilize the user device 102 (FIG. 1) to drag or move a point on the graph to the desired location. Distributional preferences are estimated using constant elasticity of substitution (CES) demand function.

As indicated in block 504, calculated risk aversion and loss aversion for each user can be verified for consistency by verifying that it satisfies Generalized Axiom of Revealed Preference (GARP). Additionally, GARP violations can be measured using an index, for example, Afriat's Critical Cost Efficiency Index (CCEI). CCEI is a number between value of 0 and 1, wherein a value of 1 indicates that the data satisfy GARP perfectly. There is no natural threshold for determining whether subjects are close enough to satisfying GARP that they can be considered utility maximizers. FIG. 2B shows how one budget constraint must be adjusted (i.e., shifted through x₂) in order to remove all violations of GARP for two decisions, endowment combination, or bundle x₁ and x₂. The CCEI is proportional to the magnitude of this adjustment and quantifies the degree of consistency (i.e., confidence intervals). The foregoing analyses can quantify the consistency of individual choices and make more precise measures of a user's attitudes toward risk and time. These measures of consistency and attitudes can also be related to observable characteristics and behaviors, thereby improving the overall human resources management process.

As indicated in block 505, the method includes mapping risk, loss, and ambiguity preference parameters, estimated via the application 118 (FIG. 1), into scores or data points with statistical confidence intervals for various use (e.g., job screening and recruiting). In one embodiment, the scores range from value of 0 to 100. There are up to three suggested scores for each functional form of utility, of which CARA and CRRA are outlined for a score for risk aversion, a score for loss aversion, and a score for ambiguity aversion.

The application 118 determines which scores to use depending on the functional form of utility (i.e., CARA, CRRA) that is used in the estimation of preference parameters in light of the preferred parameterization. For scoring risk and loss parameters and risk, loss, and ambiguity parameters, the scores describe the percentage of an individual's portfolio the individual would be willing to trade for a double-or-nothing bet of that portfolio. In scoring time preferences, given the two treatments for time assessments, the score is framed in the context of the user's willingness to wait, a personal interest or discount rate.

As indicated in block 506, the calculated scores, metrics, and parameters 106 (FIG. 1) are stored in the database 103 (FIG. 1). A user's scores and metrics define the user's point-in-time economic fingerprint 507. Thus, the user's scores and metrics can be used to determine and understand an individual's risk preferences, recommend job training, educate individuals on decision-making, and make trade-off decisions.

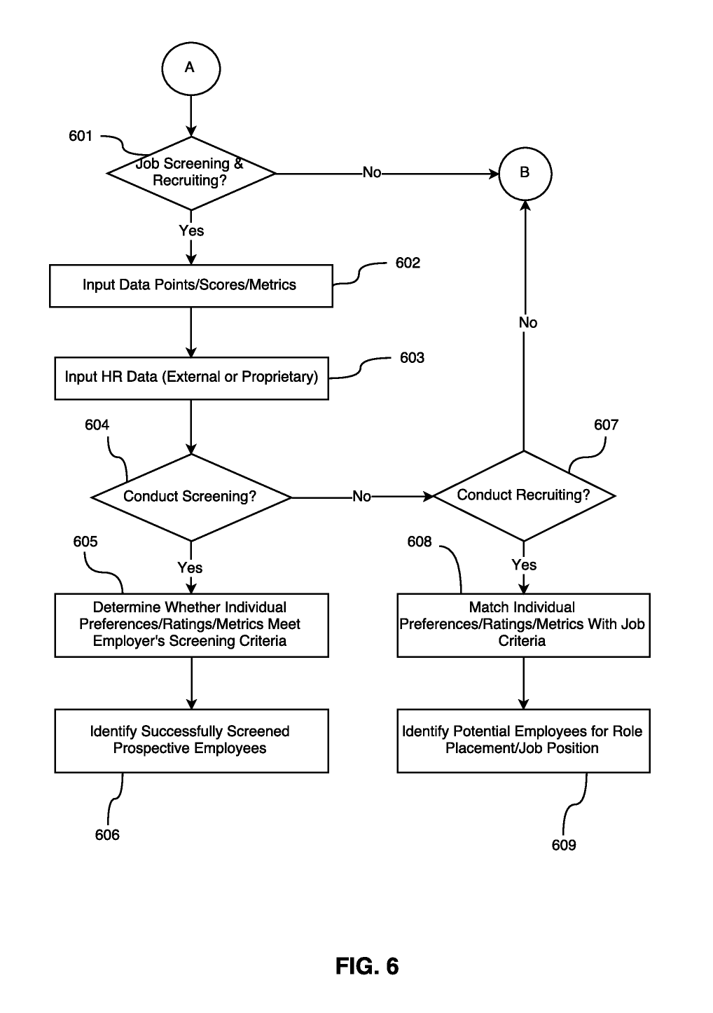

As indicated in block 508, the method includes determining an application for use. In one embodiment, the game scores or metrics 106 (FIG. 1) can be used for job screening and recruiting 601, as depicted in FIG. 6. Specifically, the job screening and recruiting process comprises the steps of inputting a user's data points, scores, and/or metrics 602; and inputting appropriate data from the HR database 109 (FIG. 1) 603, wherein the data comprises, for example, an employer's screening criteria and prerequisites/requirements for a job position.

As indicated in blocks 604 and 607, the method further includes determining whether the user's scores and metrics are being used for job screening 604 or recruiting 607. To conduct job screening, the application 118 (FIG. 1) determines whether an individual's revealed preferences and/or internally developed ratings/metrics meet the employer's screening criteria, as indicated in block 605. As indicated in block 606, the method further includes identifying successfully screened prospective employees, wherein the successfully screened prospective employees comprise employees that have met all or an acceptable number of the employee's screening criteria. For instance, the employee's screening criteria can comprise a desired range of scores or metrics where the user's scores or metrics must fall in order for the user to be considered a successfully screened prospective employee.

To conduct recruiting, the application 118 (FIG. 1) determines whether the individual's revealed preferences and/or internally developed ratings/metrics meet the job criteria or requirements, as indicated in block 608. It is contemplated that information pertaining to the job criteria or requirements are stored in the HR database 109 (FIG. 1) and/or the job marketplace 110 (FIG. 1). As indicated in block 609, the method further includes identifying potential employees for role placement or job position, wherein the potential employees comprise individuals that meet all or an acceptable number of the job criteria. As illustrated above, the job criteria can comprise a desired range of scores or metrics where the user's scores or metrics must fall in order for the user to be considered a potential employee. In this way, the present method allows for seeking new or needed talent from a group of potential employees. Additionally, the recruiting can be made internal for team assessments and/or role assignments.

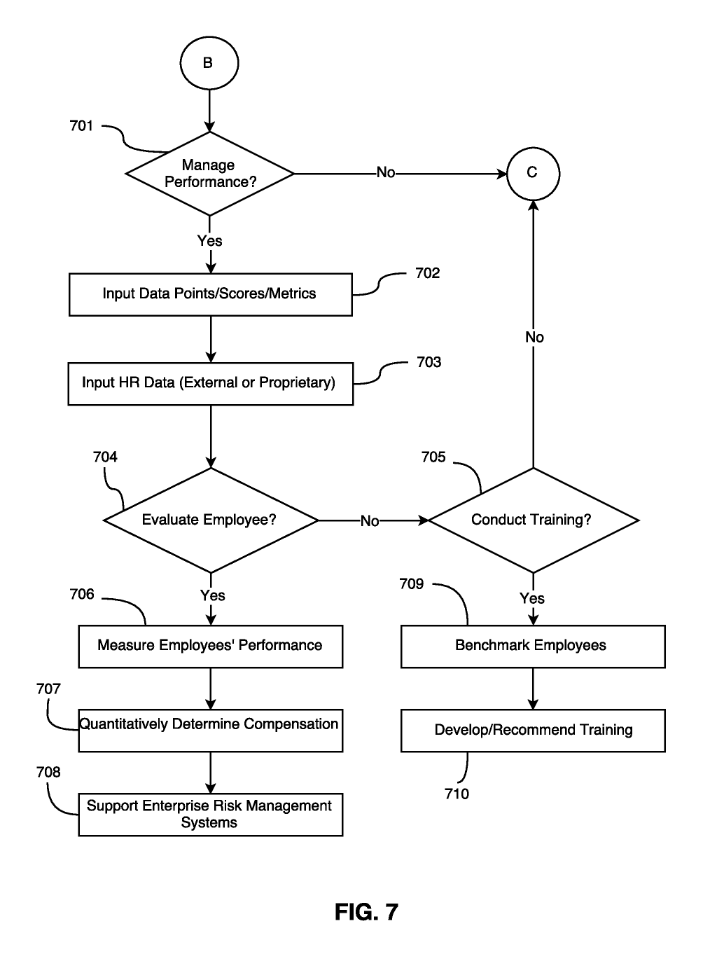

In another embodiment, internally defined utility functions and HR data can be used for managing performance, as indicated in block 701 in FIG. 7. This process comprises the steps of inputting a user's data points, scores, and/or metrics 702; and inputting appropriate data from the HR database 109 (FIG. 1) 703, wherein the data comprises, for example, a job evaluation method, required skills, required effort, responsibilities, working conditions, and other factors considered for evaluating individuals for a job position.

In some embodiments, the process for evaluating employees 704 includes measuring employees' performance 706, quantitatively determining compensation 707 (e.g., based on the employee's performance, position, role, experience, etc.) and supporting enterprise risk management systems 708, via the application 118 (FIG. 1). In this regard, the employee's performance is determined based on the employer's job evaluation method and required skills, effort, responsibilities, working conditions, and user's scores or metrics, among other factors. More specifically, the employee's performance (i.e., one or more successfully accomplished tasks and/or failed tasks) is associated with the foregoing factors for evaluating to create a benchmark. In some embodiments, the employees may be given an evaluation score based on the performance.

Additionally, managing performance includes conducting training 705. Conducting training includes benchmarking employees 709 based on the individual's revealed preferences and/or internally developed ratings/metrics and developing or recommending training 710 that is tailored to each individual. Alternatively, the application 118 (FIG. 1) may be configured to automatically recommend training if the employee's evaluation value falls below a predetermined threshold value, wherein the predetermined threshold value is internally determined by an employer and stored in the HR database 109 (FIG. 1).

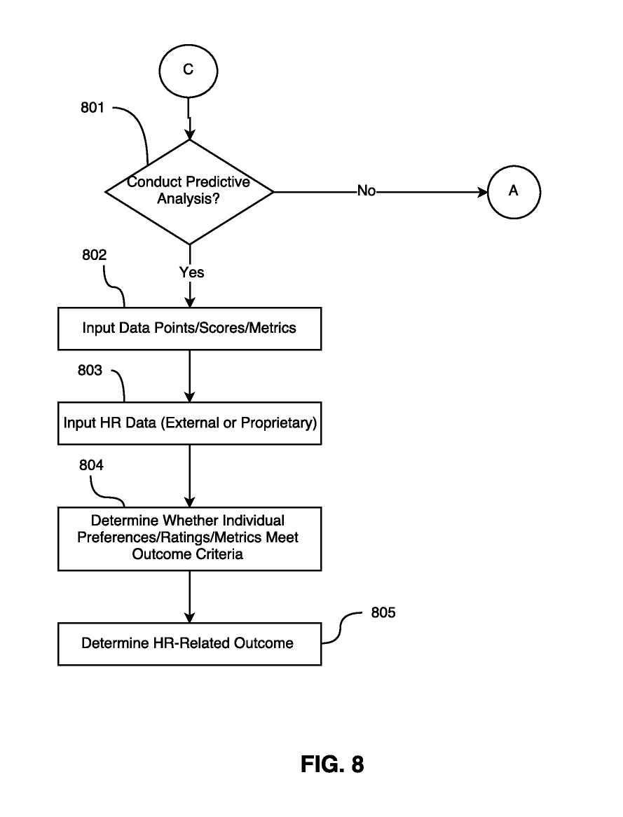

In yet another embodiment, the user's scores or metrics can be used for conducting predictive analysis 801, as depicted in FIG. 8. This process comprises the steps of inputting a user's data points, scores, and/or metrics 802; and inputting appropriate data from the HR database 109 (FIG. 1) 803, wherein the data comprises, for example, a desired outcome for a job role, a goal for a project, a target revenue, and the like. To conduct predictive analysis, the application 118 (FIG. 1) determines whether a user's data points, scores, and/or metrics meet all or some of the outcome criteria 804 so as to analyze, via the analysis module 120 (FIG. 1), the likelihood of HR-related outcomes given analysis of a universe of data and scores 805.

For example, individuals in executive roles or leadership roles can simulate decisions in varying risk, loss, time, and distributional environments revealing individual and group decision patterns on a scenario-by-scenario basis. In this regard, at least one user's data points, scores, and/or metrics can be used to determine whether the data points, scores, and/or metrics meet the outcome criteria, which can vary based on the scenario. Additionally, it is contemplated that the data points, scores, and/or metrics can be given different weights, depending on the scenario.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A computer based method, comprising the steps of:
providing, by a computing device, an activity for measuring individual preferences, wherein said individual preferences comprise risk preferences, time preferences, ambiguity preferences, and social preferences;
receiving data, by said computing device corresponding to said individual preferences of at least one user, and data from a HR database, a factor universe, and a job marketplace, wherein said job marketplace comprises information relating to job positions;
determining, by said computing device one or more parameters corresponding with said individual preferences of said at least one user; and
mapping with confidence intervals, by said computing device said one or more parameters into at least one user-specific score corresponding to said at least one user based on said individual preferences associated with said at least one user.

2. The method of claim 1, further comprising the steps of optimizing a bundle for said at least one user.

3. The method of claim 1, further comprising the steps of conducting job screening.

4. The method of claim 1, further comprising the steps of conducting job recruiting.

5. The method of claim 1, further comprising the steps of managing job performance of said at least one user for a job position correlating to said at least one user, wherein said job position is one of said job positions.

6. The method of claim 3, further comprising the steps of:
determining whether said at least one user-specific score meets an employer's screening criteria for one of said job positions, wherein said employer's screening criteria is stored in said HR database; and
if said at least one user-specific score meets said employer's screening criteria, identifying said at least one user as a successfully screened prospective employee for one of said job positions.

7. The method of claim 4, further comprising the steps of:
determining whether said at least one user-specific score meets job criteria for one of said job positions; and
if said at least one user-specific score qualifies meets said job criteria, identifying said at least one user as a potential employee for one of said job positions.

8. The method of claim 5, further comprising the steps of:
measuring a job performance of said at least one user using factors for evaluating said job performance and said at least one user-specific score;
determining compensation for said at least one user based on said job performance of said at least one user; and
supporting enterprise risk management systems.

9. The method of claim 8, further comprising the steps of:
benchmarking said at least one user for said job position associated with said at least one user; and
developing training for said job position associated with said at least one user.

10. A computer based method, comprising the steps of:
providing, by a computing device, an activity for measuring individual preferences, wherein said individual preferences comprise risk preferences, time preferences, ambiguity preferences, and social preferences, wherein said activity comprises a graph having a randomly generated budget line, further wherein said graph comprises axes that are scaled to represent economic choices based on said individual preferences being measured, further wherein said activity comprises individual decision problems;
completing said individual decision problems by allowing at least one user to move a point on said graph to a desired location on said graph using said computing device, wherein said desired location represents said individual preferences of said at least one user;
determining, by said computing device one or more parameters corresponding with said individual preferences of said at least one user; and
mapping with confidence intervals, by said computing device said one or more parameters into at least one user-specific score corresponding to said at least one user based on said individual preferences associated with said at least one user.

11. The method of claim 10, further comprising the steps of optimizing a bundle for said at least one user.

12. The method of claim 10, further comprising the steps of:
determining whether said at least one user-specific score meets an employer's screening criteria for one of said job positions, wherein said employer's screening criteria is stored in said HR database; and
if said at least one user-specific score meets said employer's screening criteria, identifying said at least one user as a successfully screened prospective employee for one of said job positions.

13. The method of claim 10, further comprising the steps of:
determining whether said at least one user-specific score meets job criteria for one of said job positions; and
if said at least one user-specific score qualifies meets said job criteria, identifying said at least one user as a potential employee for one of said job positions.

14. The method of claim 10, further comprising the steps of:
measuring a job performance of said at least one user using factors for evaluating said job performance and said at least one user-specific score;
determining compensation for said at least one user based on said job performance of said at least one user; and
supporting enterprise risk management systems.

15. The method of claim 14, further comprising the steps of:
benchmarking said at least one user for a job position associated with said at least one user, wherein said job position comprises one of said job positions; and
developing training for said job position associated with said at least one user.

16. A system, comprising:
a memory having stored thereon instructions;
a processor to execute said instructions resulting in an application;
said application configured to:
provide an activity for measuring individual preferences, wherein said individual preferences comprise risk preferences, ambiguity preferences, time preferences, and social preferences;
receive data corresponding to said individual preferences of at least one user;
determine one or more parameters corresponding with said individual preferences of said at least one user; and
map said one or more parameters into at least one user-specific score corresponding to said at least one user based on said individual preferences associated with said at least one user.

17. The system of claim 16, wherein said activity comprises a virtual reality interface.

18. The system of claim 16, wherein said activity comprises a graph having a randomly generated budget line, further wherein said graph comprises axes that are scaled to represent economic choices based on said individual preferences being measured.

19. The system of claim 16, wherein said activity is configured to allow users to solve individual decision problems by moving a point on said graph to a desired location on said graph, further wherein said desired location represents said individual preferences of said at least one user.
